(19) United States
(12) Patent Application Publication
(10) Pub. No.: US 2023/0057466 A1
(43) Pub. Date: Feb. 23, 2023

(54) ECO-FRIENDLY VEHICLE AND AIR-CONDITIONING CONTROL METHOD THEREFOR

(71) Applicants: HYUNDAI MOTOR COMPANY, Seoul (KR); KIA CORPORATION, Seoul (KR)

(72) Inventors: Se Jun Park, Suwon-si (KR); Hee Jung Yoon, Goyang-si (KR); Kyu Hyun Sim, Seoul (KR); Jong Hyuck Kim, Hwaseong-si (KR); Jin Hoe Heo, Yangju-si (KR)

(73) Assignees: HYUNDAI MOTOR COMPANY, Seoul (KR); KIA CORPORATION, Seoul (KR)

(21) Appl. No.: 17/881,116

(22) Filed: Aug. 4, 2022

(30) Foreign Application Priority Data
Aug. 19, 2021 (KR) 10-2021-0109468

(51) Int. Cl. B60H 1/00

(52) U.S. Cl. CPC B60H 1/00828; B60H 1/00807; B60H 1/00428; B60H 1/004

(57) ABSTRACT

Disclosed are a vehicle and an air-conditioning control method therefor that are capable of executing an after-blow function for an air-conditioning system without concern about discharge of a battery. The method of controlling an air-conditioning system of an eco-friendly vehicle includes determining a remaining time to a destination when a first condition related to the state of the vehicle and setting of the destination and a second condition related to an indoor temperature of the vehicle are satisfied, determining the state of the air-conditioning system related to condensation water of an evaporator of the air-conditioning system when the remaining time is equal to or less than a first time, and activating an after-blow function to stop the cooling function of the air-conditioning system and to operate a blower based on the determined state of the air-conditioning system.

This application claims the benefit of Korean Patent Application No. 10-2021-0109468, filed on Aug. 19, 2021, which is hereby incorporated by reference as if fully set forth herein.

### TECHNICAL FIELD

The present disclosure relates to an eco-friendly vehicle and an air-conditioning control method therefor that are capable of executing an after-blow function for an air-conditioning system without concern about discharge of a battery.

### BACKGROUND

In general, a vehicle is equipped with an air-conditioning system in order to increase the comfort of occupants therein by, for example, lowering the indoor temperature of the vehicle. When the air-conditioning system performs a cooling operation, a refrigerant is compressed by a compressor, and the compressed refrigerant is supplied to an evaporator and is cooled. The cooled refrigerant exchanges heat with hot air around the evaporator. In this way, the refrigerant in the evaporator absorbs heat from the indoor air, thereby cooling the indoor air.

When the air-conditioning system performs the above-described cooling operation, condensation water of the evaporator is generated. If the operation of the air-conditioning system stops in the state in which the condensation water is not dry, the moisture facilitates growth of bacteria or mold in the air-conditioning system, which causes odors and harms the health of occupants.

In order to solve this problem, vehicles provided with an after-blow function for an air-conditioning system have recently been developed. An after-blow function is a function of operating a blower for a predetermined amount of time after a vehicle is powered off in order to remove condensation water of the evaporator.

In the case of an eco-friendly vehicle, power of a low-voltage battery is used to operate a blower after power-off of the vehicle. However, when the state of charge (SOC) of the low-voltage battery is low, the after-blow function may not be executed according to setting, which may lead to contamination of the air-conditioning system. In addition, in other cases, execution of the after-blow function after power-off of the vehicle may discharge the low-voltage battery, which may make it impossible to power-on the vehicle later.

### SUMMARY OF THE DISCLOSURE

Accordingly, the present disclosure is directed to an eco-friendly vehicle and an air-conditioning control method therefor that substantially obviate one or more problems due to limitations and disadvantages of the related art.

An object of the present disclosure is to provide an eco-friendly vehicle and an air-conditioning control method therefor that are capable of executing an after-blow function for an air-conditioning system without concern about discharge of a battery.

However, the objects to be accomplished by the disclosure are not limited to the above-mentioned objects, and other objects not mentioned herein will be clearly understood by those skilled in the art from the following description.

In order to accomplish the above and other objects, a method of controlling an air-conditioning system of a vehicle according to an embodiment of the present disclosure includes determining a remaining time to a destination when a first condition related to the state of the vehicle and setting of the destination and a second condition related to an indoor temperature of the vehicle are satisfied, determining the state of the air-conditioning system related to condensation water of an evaporator of the air-conditioning system when the remaining time is equal to or less than a first time, and activating an after-blow function to stop the cooling function of the air-conditioning system and to operate a blower based on the determined state of the air-conditioning system.

For example, the first condition may include at least one of power-on of the vehicle, setting of the destination using a navigation function, execution of the cooling function, or setting of execution of the after-blow function.

For example, the second condition may be satisfied when the difference between the indoor temperature and a set temperature is within a predetermined range.

For example, the determining the state of the air-conditioning system may include determining the temperature difference between the outdoor temperature and the temperature of the evaporator.

For example, the determining the state of the air-conditioning system may further include determining that the air-conditioning system is in a first state when the temperature difference is equal to or greater than a predetermined value and determining that the air-conditioning system is in a second state when the temperature difference is less than the predetermined value.

For example, the method may further include performing state-of-charge (SOC) control to prevent discharge of a low-voltage battery configured to supply power to the blower when it is determined that the air-conditioning system is in the first state.

For example, the method may further include additionally operating the blower for a second time period after power-off of the vehicle when it is determined that the air-conditioning system is in the first state.

For example, the second time period may be the time period obtained by subtracting the time period from arrival at the destination to power-off of the vehicle from a reference time period.

For example, the method may further include terminating operation of the blower after the vehicle arrives at the destination and is powered off when it is determined that the air-conditioning system is in the second state.

For example, the reference time period may be set in consideration of the temperature difference.

In addition, a vehicle according to an embodiment of the present disclosure includes a first device, configured to perform an air-conditioning function, and a second device, configured to determine a remaining time to a destination when a first condition related to the state of the vehicle and setting of the destination and a second condition related to an indoor temperature of the vehicle are satisfied and to determine the state related to condensation water of an evaporator of the first device when the remaining time is equal to or less than a first time. The first device activates an after-blow function to stop a cooling function and to operate a blower based on the determined state.

For example, the first condition may include at least one of power-on of the vehicle, setting of the destination using a navigation function, execution of the cooling function, or setting of execution of the after-blow function.

For example, the second condition may be satisfied when the difference between the indoor temperature and a set temperature is within a predetermined range.

For example, the second device may determine the state based on the temperature difference between the outdoor temperature and the temperature of the evaporator.

For example, the second device may determine that the state is a first state when the temperature difference is equal to or greater than a predetermined value, and may determine that the state is a second state when the temperature difference is less than the predetermined value.

For example, the second device may make a request to a third device to perform state-of-charge (SOC) control to prevent discharge of a low-voltage battery configured to supply power to the blower when it is determined that the state is the first state.

For example, the first device may additionally operate the blower for a second time period after power-off of the vehicle when it is determined that the state is the first state.

For example, the second time period may be the time period obtained by subtracting the time period from arrival at the destination to power-off of the vehicle from a reference time period.

For example, the first device may terminate operation of the blower after the vehicle arrives at the destination and is powered off when it is determined that the state is the second state.

For example, the reference time period may be set in consideration of the temperature difference.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 shows an example of the configuration of a hybrid electric vehicle according to an embodiment of the present disclosure;

FIG. 2 is a diagram for explaining transmission and reception of information for execution of an after-blow function according to an embodiment of the present disclosure;

FIG. 3 shows an example of an air-conditioning system control mode according to an embodiment of the present disclosure; and

FIG. 4 is a flowchart showing an example of an air-conditioning system control process according to an embodiment of the present disclosure.

### DETAILED DESCRIPTION OF THE DISCLOSURE

Hereinafter, embodiments of the present disclosure will be described in detail with reference to the accompanying drawings so that those skilled in the art may easily carry out the embodiments. The present disclosure may, however, be embodied in many different forms, and should not be construed as being limited to the embodiments set forth herein. In the drawings, parts irrelevant to the description of the present disclosure will be omitted for clarity. Like reference numerals refer to like elements throughout the specification.

Throughout the specification, when a certain part “includes” or “comprises” a certain component, this indicates that other components are not excluded, and may be further included unless otherwise noted. The same reference numerals used throughout the specification refer to the same constituent elements.

The term “unit” or “control unit” forming part of the name of the hybrid control unit (HCU) is merely a term that is widely used in naming a controller for controlling a specific function of a vehicle, and should not be construed as meaning a generic function unit. For example, in order to control the function peculiar thereto, each control unit may include a communication device, which communicates with other control units or sensors, a memory, which stores therein an operating system, logic commands, and input/output information, and one or more processors, which perform determinations, calculations, and decisions necessary for control of the function peculiar thereto.

In an eco-friendly vehicle provided with an after-blow function according to embodiments of the present disclosure, the time point of commencement of an after-blow function may be determined using a remaining time to a destination based on navigation information. In addition, when the after-blow function is executed, a low-voltage battery may be charged with the power of a high-voltage battery before the vehicle is powered off in consideration of the state of charge of the low-voltage battery. In addition, the after-blow function may be additionally executed even after power-off of the vehicle depending on the state of an air-conditioning system.

Hereinafter, an eco-friendly vehicle and an air-conditioning control method therefor according to embodiments of the present disclosure will be described with reference to the accompanying drawings. The following description will be made on the assumption that the eco-friendly vehicle is a hybrid electric vehicle (HEV), but this is merely for convenience of explanation. The following description may also identically apply to other types of eco-friendly vehicles equipped with air-conditioning systems, such as electric vehicles (EVs).

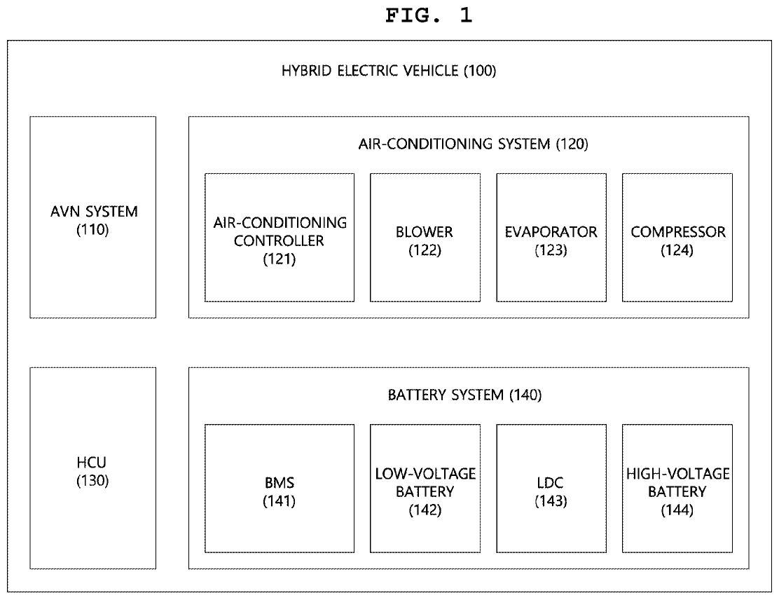

FIG. 1 shows an example of the configuration of a hybrid electric vehicle according to an embodiment of the present disclosure.

Referring to FIG. 1, a hybrid electric vehicle 100 according to an embodiment may include an audio/video/navigation (AVN) system 110, an air-conditioning system 120, a hybrid control unit (HCU) 130, and a battery system 140.

The air-conditioning system 120 may include an air-conditioning controller 121, a blower 122, an evaporator 123, and a compressor 124. The battery system 140 may include a battery management system (BMS) 141, a low-voltage battery 142, a low DC-DC converter (LDC) 143, and a high-voltage battery 144.

FIG. 1 illustrates components related to embodiments of the present disclosure. In practice, the hybrid electric vehicle 100 may include a greater number of components, such as a drive motor and an engine.

The AVN system 110 functions to reproduce media, such as audio or video. In relation to the embodiments of the present disclosure, when a destination is set, the AVN system 110 may determine a remaining time to the destination (hereinafter referred to as “estimated time of arrival (ETA)”). In addition, when the ETA is equal and less than a predetermined value, the AVN system 110 may provide information about this situation to the HCU 130. In addition, the AVN system 110 may receive a command related to execution or termination of the after-blow operation or setting change input through a predetermined input device (e.g., a touch screen, a touch button, a key button, a dial, a switch, etc.), and may provide information about the command or the input to the air-conditioning controller 121 and the HCU 130.

The air-conditioning system 120 may control circulation of inside air and introduction of outside air depending on manipulation or setting by the user, and may perform a cooling or heating operation in order to adjust the indoor temperature of the vehicle. The air-conditioning controller 121 may also be called a full automatic temperature control (FATC) unit. In relation to the embodiment of the present disclosure, the air-conditioning controller 121 may determine the state of the air-conditioning system based on information acquired by sensors (not shown) provided in the air-conditioning system or the vehicle, such as an indoor temperature, an outdoor temperature, and the temperature of the evaporator 123, and may perform control such that the operation of the compressor 124 stops and only the blower 122 is driven in order to execute the after-blow operation.

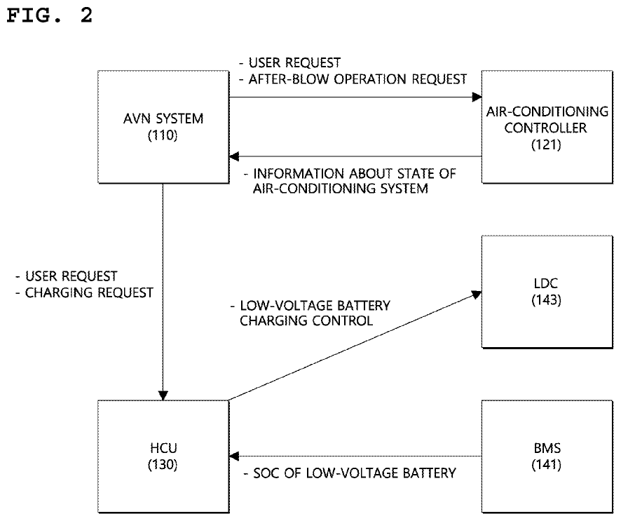

The HCU 130 is a higher-level control unit that controls the overall operation of the powertrain of the hybrid electric vehicle, and an engine control unit (not shown) and a motor control unit (not shown) may be provided as lower-level control units of the HCU 130. In relation to the embodiment of the present disclosure, the HCU 130 may manage the state of charge (SOC) of the low-voltage battery 142 in response to a charging request for the after-blow function, which is received from the AVN system 110. This will be described later in more detail with reference to FIG. 2.

The BMS 141 of the battery system 140 may sense the states of the batteries 142 and 144 (e.g., voltage, current, temperature, SOC, etc.), and may provide information about the states of the batteries to the HCU 130. The low-voltage battery 142 generally has a voltage of around 12V, but the disclosure is not limited thereto. The low-voltage battery 142 may supply power to various electric components of the vehicle, including the blower 122 of the air-conditioning system 120. The LDC 143 may convert the power of the high-voltage battery 144 to charge the low-voltage battery 142 under the control of the HCU 130.

In the case in which the eco-friendly vehicle according to the embodiment of the present disclosure is an electric vehicle (EV), rather than a hybrid electric vehicle, the above-described configuration is modified such that the HCU 130 is substituted with a control unit that performs a function corresponding to the function of the HCU 130 in the electric vehicle, for example, a vehicle control unit (VCU). It will be apparent to those skilled in the art that the configuration related to the after-blow function can be appropriately changed depending on the type of eco-friendly vehicle.

FIG. 2 is a diagram for explaining transmission and reception of information for execution of the after-blow function according to an embodiment of the present disclosure.

Referring to FIG. 2, the AVN system 110 may transmit a user request and an after-blow operation request to the air-conditioning controller 121, and may receive information about the state of the air-conditioning system from the air-conditioning controller 121. Here, the user request may correspond to setting information or a user command, and the setting information or the command may relate to execution or termination of the after-blow operation. That is, when receiving “after-blow operation on” as a user request, the air-conditioning controller 121 may transmit information about the state of the air-conditioning system to the AVN system 110. The information about the state of the air-conditioning system may include whether an indoor temperature has reached a set temperature, an outdoor temperature, and the temperature of the evaporator 123. The outdoor temperature and the temperature of the evaporator 123 may be replaced with a value indicating the difference between the two temperatures.

In addition, when the ETA is equal to or less than a predetermined value, the AVN system 110 may transmit an after-blow operation request to the air-conditioning controller 121. Here, the after-blow operation request may include information about whether to continue to operate the blower 122 for a predetermined amount of time after power-off of the vehicle.

Meanwhile, the AVN system 110 may transmit a user request and a charging request to the HCU 130. Since the user request that is transmitted to the HCU 130 is similar to the user request that is transmitted to the air-conditioning controller 121, a duplicate description thereof will be omitted. The AVN system 110 may determine whether it is necessary to continue to operate the blower 122 after power-off of the vehicle based on the information about the state of the air-conditioning system. Upon determining that it is necessary to continue to operate the blower 122 after power-off of the vehicle, the AVN system 110 may transmit a charging request to the HCU 130.

When receiving the charging request from the AVN system 110, the HCU 130 may check the SOC of the low-voltage battery 142 obtained using the BMS 141. When the current SOC of the low-voltage battery 142 is lower than a predetermined SOC, the HCU 130 may determine that the low-voltage battery 142 is likely to be discharged by the operation of the blower 122 after power-off of the vehicle. In this case, the HCU 130 makes a request to the LDC 143 to charge the low-voltage battery 142. Here, the predetermined SOC may be set to a value obtained by summing a minimum SOC (e.g., a critical low SOC) necessary for subsequent power-on and efficient operation of the eco-friendly vehicle and an SOC corresponding to the amount of power necessary to operate the blower 122 for a predetermined amount of time after power-off of the vehicle. However, this is merely illustrative, and the disclosure is not limited thereto. When the low-voltage battery 142 is charged by the LDC 143, the HCU 130 may monitor the SOC of the low-voltage battery 142 using the BMS 141. When the SOC of the low-voltage battery 142 reaches the above-described predetermined SOC, the HCU 130 may make a request to the LDC 143 to stop charging.

Meanwhile, according to another embodiment, the HCU 130 may determine the necessity of charging and the amount of charging based on the information about the state of the air-conditioning system received from the air-conditioning controller 121, rather than receiving the charging request from the AVN system 110.

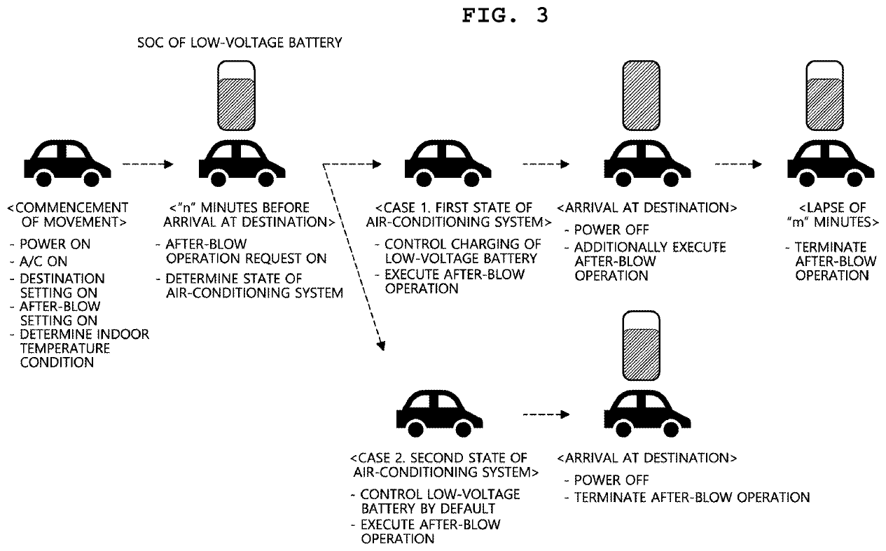

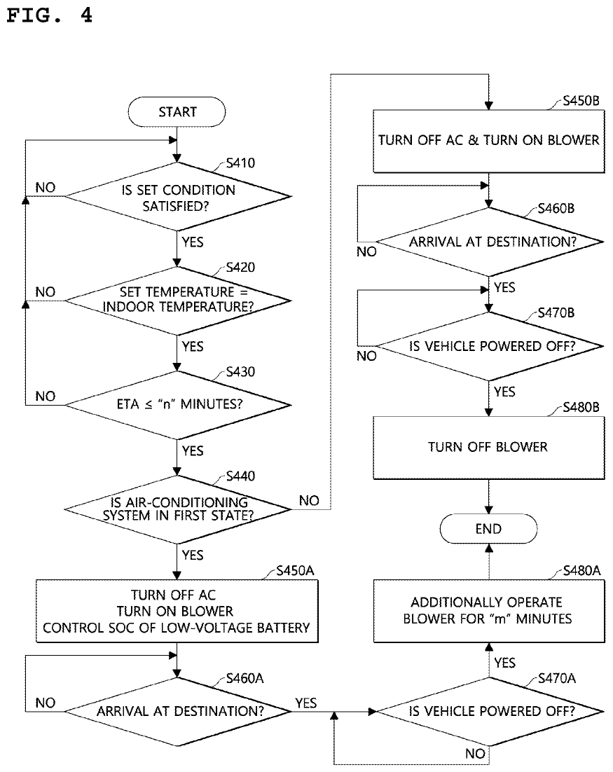

Hereinafter, an air-conditioning system control mode will be described in detail with reference to FIGS. 3 and 4.

FIG. 3 shows an example of an air-conditioning system control mode according to an embodiment of the present disclosure, and FIG. 4 is a flowchart showing an example of an air-conditioning system control process according to an embodiment of the present disclosure.

Referring to FIGS. 3 and 4 together, when movement of the vehicle commences, the AVN system 110 determines whether a set condition for provision of the after-blow function according to the embodiment is satisfied (S410). Here, the situation in which the set condition is satisfied may be a situation in which the power-on state, the cooling (air-conditioning (A/C)) on state in which at least the compressor 124 of the air-conditioning system 120 is driven and thus moisture is likely to be generated on the surface of the evaporator, the state in which a destination is set through the navigation function of the AVN system 110, and the state in which the user makes a setting to execute the after-blow function are all satisfied.

When the set condition is satisfied (Yes in S410), the AVN system 110 may transmit a user request to the air-conditioning controller 121, may receive information about the state of the air-conditioning system, and may determine whether an indoor temperature condition is satisfied based on the information about the state of the air-conditioning system (S420). The indoor temperature condition pertains to whether an indoor temperature has reached a set temperature. In the state in which the indoor temperature condition is not satisfied, it is necessary to preferentially perform control such that the indoor temperature reaches the set temperature. The reason for this is that the compressor 124 needs to be turned off when the after-blow function is executed. In step S420, when the indoor temperature equals the set temperature, it may be determined that the indoor temperature condition is satisfied.

Alternatively, it may be determined that the indoor temperature condition is satisfied when the difference between the indoor temperature and the set temperature is within a predetermined range.

In the state in which both the set condition and the indoor temperature condition are satisfied (Yes in S420), the AVN system 110 determines the ETA to the destination (S430). When the ETA is equal to or less than a predetermined time (e.g., “n” minutes) (Yes in S430), the AVN system 110 determines the state of the air-conditioning system (S440).

Here, the AVN system 110 may output information indicating that the after-blow function is being executed through a pop-up window or the like output on the display. In some embodiments, even if the indoor temperature condition is not satisfied in step S420, when the condition related to the ETA is satisfied in step S430, the AVN system 110 may query the driver about whether to execute the after-blow function.

According to an embodiment, the determination of the state of the air-conditioning system in step S440 may be the determination of the difference between the outdoor temperature and the temperature of the evaporator 123. When the temperature difference is equal to or greater than a predetermined value, the AVN system 110 may determine that the air-conditioning system is in a first state, and when the temperature difference is less than the predetermined value, the AVN system 110 may determine that the air-conditioning system is in a second state. Here, a large temperature difference may mean that a relatively large amount of moisture is present on the surface of the evaporator 123, and may also mean that it is necessary to operate the blower 122 for a relatively long time period. The “n” minutes may correspond to the time period for which it is possible to dry the evaporator 123 using the after-blow function when the air-conditioning system is in the second state, but the disclosure is not limited thereto. In addition, the time period for which it is possible to dry the evaporator 123 using the after-blow function may vary depending on the specifications of the blower 122, the outdoor temperature, the outdoor humidity, and the structure of the air-conditioning system, and may be a value obtained through experimentation performed under predetermined conditions for respective vehicle models.

The two states of the air-conditioning system described above are merely illustrative. In some embodiments, the state of the air-conditioning system may be determined based on subdivision into a greater number of states. In addition, the operation time period of the blower 122 for the after-blow function may be determined taking into account the temperature difference.

When it is determined that the air-conditioning system is in the first state (Yes in S440), the AVN system 110 transmits an after-blow operation request to the air-conditioning controller 121, and transmits a charging request to the HCU 130. In this case, the after-blow operation request may include information requesting operation of the blower 122 after power-off of the vehicle. Accordingly, the air-conditioning controller 121 stops the operation of the compressor 124 (i.e., turns off A/C) and operates the blower 122, and the HCU 130 performs the above-described SOC control according to the SOC of the low-voltage battery 142 in response to the charging request (S450A). Here, the air-conditioning controller 121 may control the air circulation mode to the outside air introduction mode, and may control a temperature door so that the maximum amount of air moves to the evaporator 123 in order to more rapidly remove moisture present on the surface of the evaporator 123. Here, the temperature door is a device that adjusts the ratio of the amount of air moving to the heat source (e.g., coolant) to the amount of air moving to the cooling source (i.e. the evaporator) in order to adjust the temperature of the air that is supplied to the passenger compartment of the vehicle.

When the vehicle arrives at the destination (Yes in S460A), and when the vehicle is powered off (Yes in S470A), operation of the blower 122 may continue in order to completely dry the evaporator 123 because the evaporator 123 is in the first state, in which a relatively large amount of moisture is present on the surface of the evaporator 123 (S480A). Here, the additional operation time period (“m” minutes) of the blower 122 may be a reference time period, or may be a time period obtained by subtracting a time period from arrival at the destination to power-off of the vehicle from a reference time period. In addition, the reference time period may be a predetermined time period, or may be variably set taking into account the difference between the outdoor temperature and the temperature of the evaporator 123 at the time point of determination of the state of the air-conditioning system (e.g., S440).

Meanwhile, when the air-conditioning system is in the second state (No in S440), the AVN system 110 transmits an after-blow operation request to the air-conditioning controller 121. Accordingly, the air-conditioning controller 121 may stop the operation of the compressor 124 (i.e., turn off A/C), and may operate the blower 122 (S450B). Here, similar to step S450A, the air-conditioning controller 121 may control the air circulation mode to the outside air introduction mode, and may control the temperature door so that the maximum amount of air moves to the evaporator 123 in order to more rapidly remove moisture present on the surface of the evaporator 123. Since the AVN system 110 does not transmit the charging request to the HCU 130, the HCU 130 may control the SOC of the low-voltage battery 142 by default.

When the vehicle arrives at the destination (Yes in S460B), and when the vehicle is powered off (Yes in S470B), the blower 122 may be turned off (S480B).

It has been described above that the AVN system 110 performs the function of transmitting the user request and the after-blow operation request to the air-conditioning controller 121, the function of determining the state of the air-conditioning system based on the information about the state of the air-conditioning system, and the function of transmitting the user request and the charging request to the HCU 130. However, this is merely illustrative, and the disclosure is not limited thereto. For example, at least one of the above functions may be performed by the HCU 130, the air-conditioning controller 121, or another device that is capable of communicating with the AVN system 110, the air-conditioning controller 121, and the HCU 130.

According to the embodiments described above, when a destination is set using the navigation system, control of the after-blow operation may commence before the vehicle is powered off. In addition, when it is determined that the after-blow operation needs to be continuously controlled even after power-off of the vehicle, the SOC of the auxiliary battery may be managed in order to prevent or minimize the occurrence of discharge of the auxiliary battery.

The present disclosure described above may be implemented as code that can be written on a computer-readable recording medium and thus read by a computer system. The computer-readable recording medium includes all kinds of recording devices in which data that may be read by a computer system are stored. Examples of the computer-readable recording medium include a Hard Disk Drive (HDD), a Solid-State Disk (SSD), a Silicon Disk Drive (SDD), a Read-Only Memory (ROM), a Random Access Memory (RAM), a Compact Disk ROM (CD-ROM), a magnetic tape, a floppy disc, and an optical data storage. When a corresponding processor (such as a processor of the AVN system 110, a processor of HCU 130, a processor of BMS 141, and a processor of the air-conditioning system 120) executes the code, the corresponding processor may be configured to perform the above-described operations.

As is apparent from the above description, an eco-friendly vehicle related to at least one embodiment of the present disclosure configured as described above may execute an after-blow function for an air-conditioning system without concern about discharge of an auxiliary battery.

Particularly, the time point of operation of the after-blow function, whether to charge the low-voltage battery, and whether to execute the after-blow operation after power-off of the vehicle may be determined based on navigation information and the state of the air-conditioning system. Accordingly, the air-conditioning system may be kept clean.

However, the effects achievable through the present disclosure are not limited to the above-mentioned effects, and other effects not mentioned herein will be clearly understood by those skilled in the art from the above description.

It will be apparent to those skilled in the art that various changes in form and details may be made without departing from the spirit and essential characteristics of the disclosure set forth herein. Accordingly, the above detailed description is not intended to be construed to limit the disclosure in all aspects and to be considered by way of example. The scope of the disclosure should be determined by reasonable interpretation of the appended claims and all equivalent modifications made without departing from the disclosure should be included in the following claims.

What is claimed is:

1. A method of controlling an air-conditioning system of a vehicle, the method comprising:
determining a remaining time to a destination when a first condition related to a state of the vehicle and setting of the destination and a second condition related to an indoor temperature of the vehicle are satisfied;
determining a state of the air-conditioning system related to condensation water of an evaporator of the air-conditioning system when the remaining time is equal to or less than a first time; and
activating an after-blow function to stop a cooling function of the air-conditioning system and to operate a blower based on the determined state of the air-conditioning system.

2. The method according to claim 1, wherein the first condition comprises at least one of power-on of the vehicle, setting of the destination using a navigation function, execution of the cooling function, or setting of execution of the after-blow function.

3. The method according to claim 1, wherein the second condition is satisfied when a difference between the indoor temperature and a set temperature is within a predetermined range.

4. The method according to claim 1, wherein determining the state of the air-conditioning system comprises determining a temperature difference between an outdoor temperature and a temperature of the evaporator.

5. The method according to claim 4, wherein determining the state of the air-conditioning system further comprises:
determining that the air-conditioning system is in a first state when the temperature difference is equal to or greater than a predetermined value; and
determining that the air-conditioning system is in a second state when the temperature difference is less than the predetermined value.

6. The method according to claim 5, further comprising:
performing state-of-charge control to prevent discharge of a low-voltage battery configured to supply power to the blower when it is determined that the air-conditioning system is in the first state.

7. The method according to claim 5, further comprising:
additionally operating the blower for a second time period after power-off of the vehicle when it is determined that the air-conditioning system is in the first state.

8. The method according to claim 7, wherein the second time period is a time period obtained by subtracting a time period from arrival at the destination to power-off of the vehicle from a reference time period.

9. The method according to claim 5, further comprising:
terminating operation of the blower after the vehicle arrives at the destination and is powered off when it is determined that the air-conditioning system is in the second state.

10. The method according to claim 8, wherein the reference time period is set in consideration of the temperature difference.

11. A vehicle, comprising:
a first device configured to perform an air-conditioning function; and
a second device configured to determine a remaining time to a destination when a first condition related to a state of the vehicle and setting of the destination and a second condition related to an indoor temperature of the vehicle are satisfied and to determine a state related to condensation water of an evaporator of the first device when the remaining time is equal to or less than a first time,
wherein the first device activates an after-blow function to stop a cooling function and to operate a blower based on the determined state.

12. The vehicle according to claim 11, wherein the first condition comprises at least one of power-on of the vehicle, setting of the destination using a navigation function, execution of the cooling function, or setting of execution of the after-blow function.

13. The vehicle according to claim 11, wherein the second condition is satisfied when a difference between the indoor temperature and a set temperature is within a predetermined range.

14. The vehicle according to claim 11, wherein the second device determines the state based on a temperature difference between an outdoor temperature and a temperature of the evaporator.

15. The vehicle according to claim 14, wherein the second device determines that the state is a first state when the temperature difference is equal to or greater than a predetermined value, and determines that the state is a second state when the temperature difference is less than the predetermined value.

16. The vehicle according to claim 15, wherein the second device makes a request to a third device to perform state-of-charge control to prevent discharge of a low-voltage battery configured to supply power to the blower when it is determined that the state is the first state.

17. The vehicle according to claim 15, wherein the first device additionally operates the blower for a second time period after power-off of the vehicle when it is determined that the state is the first state.

18. The vehicle according to claim 17, wherein the second time period is a time period obtained by subtracting a time period from arrival at the destination to power-off of the vehicle from a reference time period.

19. The vehicle according to claim 15, wherein the first device terminates operation of the blower after the vehicle arrives at the destination and is powered off when it is determined that the state is the second state.

20. The vehicle according to claim 18, wherein the reference time period is set in consideration of the temperature difference.
